(19) United States
(12) Patent Application Publication
(10) Pub. No.: US 2024/0154873 A1
(43) Pub. Date: May 9, 2024

(54) PORTABLE VIRTUAL IOT APPARATUS, VIRTUAL DEVICE DATA GENERATION METHOD USING SAME, AND PROGRAM OF SAME

(71) Applicant: Panasonic Holdings Corporation, Osaka (JP)

(72) Inventor: Mitsuru UESUGI, Kanagawa (JP)

(73) Assignee: Panasonic Holdings Corporation, Osaka (JP)

(21) Appl. No.: 18/274,573

(22) PCT Filed: Jan. 17, 2022
(86) PCT No.: PCT/JP2022/001443

§ 371 Date: Jul. 27, 2023

(30) Foreign Application Priority Data
Jan. 28, 2021 (JP) 2021-012316

(51) Int. Cl. H04L 41/0895; G16Y 10/75; G16Y 20/10; H04L 41/0806

(52) U.S. Cl. CPC H04L 41/0895; G16Y 10/75; G16Y 20/10; H04L 41/0806

(57) ABSTRACT

A portable virtual IoT apparatus for generating virtual device data based on data collected by one or more physical devices forming an IoT network, performs operations including: acquiring information about physical devices present in a target area; acquiring collected data, which is data collected by the physical devices in the target area, by communicatively connecting to the physical devices based on the information about the physical devices; and generating the virtual device data based on the data collected by the physical devices.

### TECHNICAL FIELD

The present invention relates to a portable virtual IoT apparatus for generating virtual device data, the virtual device data being data to be provided from virtual devices, based on data collected by one or more physical devices forming an IoT network, a virtual device data generation method using the same, and a computer program of the same.

### BACKGROUND ART

In recent years, the Internet-of-things (IoT) technologies are attracting more attention. The IoT technology generally utilizes various physical devices (IoT devices) that are present in the world as sensors, to enable a large number of users to share various data collected from these physical devices via the Internet.

Technologies for virtualizing IoT devices are also known (see Patent Document 1). In such a technology for virtualizing IoT devices, a system can process data collected by one or more physical devices to generate data to be provided from IoT devices that do not actually exist (virtual devices). In such a technology of virtualizing IoT devices, a system can perform a certain image analysis on data detected by a camera (i.e., captured images) to thereby enable different uses of the same camera. For example, one user can use the camera as a person detection device, and another user can use it as a crowdedness detection device, while yet another user can use it as a wildlife detection device for vermin control.

### PRIOR ART DOCUMENT(S)

### Patent Document(s)

Patent Document 1: JP2018-527651A

### SUMMARY OF THE INVENTION

### Task to be Accomplished by the Invention

In the prior art, a system for virtualizing IoT devices is generally composed of components built in a cloud, and only a predetermined smart city can be connected to the system, in which only predetermined physical devices can be used.

Thus, it is difficult for virtual IoT systems of the prior art to be used in areas where generation of virtual device data is temporarily needed (e.g., event sites, disaster sites, incident scenes) and quickly acquire virtual device data using physical devices installed on site. Moreover, there can also be physical devices that are not remotely accessible (e.g., not connected to the Internet) in such areas, and it is difficult for virtual IoT systems of the prior art to acquire data collected by such isolated physical devices.

The present invention has been made in view of such problems of the prior art, and a primary object of the present invention is to provide a portable virtual IoT apparatus for generating virtual device data, the virtual device data being data to be provided from virtual devices, based on data collected by one or more physical devices present on site, a virtual device data generation method using the same, and a computer program of the same, which enable quickly acquisition of virtual device data, i.e., data to be provided from virtual devices.

### Means to Accomplish the Task

An aspect of the present invention provides a method of generating virtual device data, the virtual device data being data to be provided from virtual devices, by using a portable virtual IoT apparatus based on data collected by one or more physical devices forming an IoT network, the method comprising: causing the virtual IoT apparatus to perform operations including: acquiring information about physical devices present in a target area; acquiring collected data, which is data collected by the physical devices in the target area, by communicatively connecting to the physical devices based on the information about the physical devices; and generating the virtual device data based on the collected data from the physical devices.

Another aspect of the present invention provides a portable virtual IoT apparatus comprising a processor configured to generate virtual device data, the virtual device data being data to be provided from virtual devices, based on data collected by one or more physical devices forming an IoT network, wherein the processor is configured to perform operations including: acquiring information about physical devices present in a target area; acquiring collected data, which is data collected by the physical devices in the target area, by communicatively connecting to the physical devices based on the information about the physical devices; and generating the virtual device data based on the collected data from the physical devices.

Yet another aspect of the present invention provides a program of controlling a computer to operate as a portable virtual IoT apparatus that generates virtual device data, the virtual device data being data to be provided from virtual devices, based on data collected by one or more physical devices forming an IoT network, wherein the program causes a processor of the computer to perform operations including: acquiring information about physical devices present in a target area; acquiring collected data, which is data collected by the physical devices in the target area, by communicatively connecting to the physical devices based on the information about the physical devices; and generating the virtual device data based on the collected data from the physical devices.

### Effect of the Invention

According to the present invention, a portable virtual IoT apparatus can quickly acquire virtual device data, i.e., data to be provided from virtual devices, based on data collected by physical devices present on site.

### BRIEF DESCRIPTION OF THE DRAWINGS

FIG. 1 is a diagram showing an overall configuration of a virtual IoT system with a portable virtual IoT apparatus according to a first embodiment of the present invention;

FIG. 2 is an explanatory diagram showing an example of virtual device data generation by using the virtual IoT apparatus;

FIG. 3 is a functional block diagram of a virtual IoT apparatus;

FIG. 4 is a flow chart showing an operation procedure of an operation of virtual device data generation;

FIG. 5 is a diagram showing an overall configuration of a virtual IoT system according to a variant of the first embodiment of the present invention;

FIG. 6 is an explanatory diagram showing an example of restriction on use of data collected by physical devices;

FIG. 7 is a flow chart showing an operation procedure of an operation of data inquiry from a virtual IoT apparatus to physical devices;

FIG. 8 is a flow chart showing an operation procedure of an operation to provide dummy data from a physical device to the virtual IoT apparatus;

FIG. 9 is a functional block diagram of a virtual IoT apparatus according to a second embodiment of the present invention;

FIG. 10 is an explanatory diagram showing an example of deficiency of physical devices;

FIG. 11 is an explanatory diagram showing an example of deficiency of physical devices;

FIG. 12 is a flow chart showing an operation procedure of an operation of virtual device data generation according to the second embodiment;

FIG. 13 is a diagram showing an overall configuration of a virtual IoT system with a portable virtual IoT apparatus according to a third embodiment of the present invention;

FIG. 14 is an explanatory diagram showing an example of communication connection and data transfer between a virtual IoT apparatus and other virtual IoT apparatuses; and

FIG. 15 is a diagram showing an overall configuration of a virtual IoT system according to a variant of the third embodiment of the present invention.

### DESCRIPTION OF THE PREFERRED EMBODIMENT(S)

A first aspect of the present invention made to achieve the above-described object is a method of generating virtual device data, the virtual device data being data to be provided from virtual devices, by using a portable virtual IoT apparatus based on data collected by one or more physical devices forming an IoT network, the method comprising: causing the virtual IoT apparatus to perform operations including: acquiring information about physical devices present in a target area; acquiring collected data, which is data collected by the physical devices in the target area, by communicatively connecting to the physical devices based on the information about the physical devices; and generating the virtual device data based on the collected data from the physical devices.

According to this configuration, the virtual IoT apparatus can quickly acquire virtual device data, i.e., data to be provided from virtual devices, based on data collected by physical devices present on site (in a target area).

A second aspect of the present invention is the method of the first aspect, wherein at least one of the physical devices has wireless communication capabilities, and wherein the virtual IoT apparatus is caused to: detect physical devices present in the target area based on wireless signals transmitted therefrom; and acquire the collected data from the physical devices by communicatively connecting to each of the detected physical devices.

In this configuration, the virtual IoT apparatus can acquire collected data from physical devices detected by wireless signals even when information about at least some of the physical devices present in the target area is not available (i.e., when presence of some of the physical devices is not publicly known).

A third aspect of the present invention is the method of the first or second aspect, wherein the virtual IoT apparatus is caused to: determine whether or not the physical devices are deficient for generating the virtual device data based on the information about the physical devices; and when determining that the physical devices are deficient, inform a user of the deficiency of the physical devices.

In this configuration, the virtual IoT apparatus can inform a user of deficiency of physical devices to thereby encourage the user to install necessary physical devices.

A fourth aspect of the present invention is the method of the third aspect, wherein the virtual IoT apparatus is caused to: inform the user of a fact that a number or density of physical devices present in the target area is not sufficient to generate the virtual device data, as the deficiency of the physical devices.

In this configuration, the virtual IoT apparatus can inform a user of lack of physical devices in the target area to thereby encourage the user to install additional necessary physical devices.

A fifth aspect of the present invention is the method of the third or fourth aspect, wherein the virtual IoT apparatus is caused to: inform the user of a fact that specifications of physical devices present in the target area are not sufficient to generate the virtual device data, as the deficiency of the physical devices.

In this configuration, the virtual IoT apparatus can inform a user of a fact that specifications of physical devices present in the target area are not sufficient to thereby encourage the user to install additional necessary physical devices and make a change (relaxation) in the specifications of necessary physical devices.

A sixth aspect of the present invention is the method of any of the first to fifth aspects, wherein the collected data from the physical devices is set such that authorization is required to use the collected data, and wherein the virtual IoT apparatus can generate the virtual device data based on the collected data from the physical devices only when the virtual IoT apparatus is authorized to access the data.

In this configuration, the virtual IoT apparatus does not use collected data from physical devices which the apparatus is not authorized to use, and thus an administrator of physical devices can easily ensure security of collected data from the physical devices.

A seventh aspect of the present invention is the method of the sixth aspect, wherein a usable time period is defined such that the authorization to use the collected data is valid only during the usable time period, and wherein the virtual IoT apparatus can generate the virtual device data based on the collected data from the physical devices only during the usable time period.

In this configuration, the virtual IoT apparatus does not use collected data from physical devices outside the usable time period, and thus an administrator of physical devices can easily ensure security of collected data from the physical devices.

An eighth aspect of the present invention is the method of any of the first to seventh aspects, wherein the virtual IoT apparatus is caused to: acquire a provisional authorization to use the collected data from the physical devices; and transmit a data request to the physical devices based on the provisional authorization, and wherein, when a physical device receives the data request based on the provisional authorization from the virtual IoT apparatus, the physical device transmits dummy data associated with the collected data to the virtual IoT apparatus.

In this configuration, the virtual IoT apparatus can do trial use of collected data from physical devices based on their dummy data. Thus, a user of the virtual IoT apparatus can preliminarily check whether or not the collected data from the desired physical device is actually available for virtual device data generation.

A ninth aspect of the present invention is the method of any of the first to eighth aspects, wherein, before acquiring the collected data from the physical devices, the virtual IoT apparatus transmits to the physical devices an inquiry as to whether or not the collected data includes specific data, and wherein, when a physical device receives the inquiry, the physical device transmits a response to the inquiry to the virtual IoT apparatus.

In this configuration, the virtual IoT apparatus can preliminarily check whether or not specific data required for virtual device data generation is included in collected data from physical devices, thereby preventing unnecessary data acquisition.

A tenth aspect of the present invention is the method of the ninth aspect, wherein the collected data includes image data, wherein the specific data is data of a subject required to generate the virtual device data.

In this configuration, the virtual IoT apparatus can preliminarily check whether or not subject data required for virtual device data generation is included in image data collected by physical devices, thereby enabling protection of the privacy of unrelated persons and others in the image data.

An eleventh aspect of the present invention is the method of any of the first to tenth aspects, wherein a local network isolated from the Internet is provided in the target area, wherein the physical devices and a local server for acquiring the collected data from the physical devices are connected to the local network, and wherein the virtual IoT apparatus is communicatively connected to the local server to thereby acquire the collected data from the physical devices via the local server.

In this configuration, the virtual IoT apparatus can easily acquire, via the local server, collected data from isolated physical devices that are not connected to the Internet.

A twelfth aspect of the present invention is the method of the eleventh aspect, wherein the local server transmits the collected data from the physical devices to the virtual IoT apparatus only when the virtual IoT apparatus is authorized to access the local server.

In this configuration, a virtual IoT apparatus is not allowed to use collected data from physical devices which the virtual IoT apparatus is unauthorized to access, and thus an administrator of the local server can easily ensure security of collected data from the physical devices connected to the local network.

A thirteenth aspect of the present invention is the method of the eleventh aspect, wherein the collected data from the physical devices is set such that authorization defined for each data attribute is required to use the data, and wherein the local server transmits only the collected data with data attributes for which the virtual IoT apparatus has the authorization to use, to the virtual IoT apparatus.

In this configuration, a virtual IoT apparatus is not allowed to use collected data with the data attribute for which the virtual IoT apparatus is unauthorized to use, and thus an administrator of the local server can easily ensure security of collected data from the physical devices connected to the local network.

A fourteenth aspect of the present invention is the method of any of the first to tenth aspects, wherein a local network isolated from the Internet is provided in the target area, wherein the physical devices are connected to the local network, and wherein the virtual IoT apparatus acquires the information about the physical devices via the Internet.

In this configuration, the virtual IoT apparatus can acquire information about physical devices via the Internet without moving to the target area. In addition, a user of the virtual IoT apparatus can preliminarily check whether or not a physical device required for virtual device data generation is present in the target area.

A fifteenth aspect of the present invention is the method of the first to fourteenth aspects, wherein the virtual IoT apparatus is communicatively connected to one or more other virtual IoT apparatuses; and wherein the other virtual IoT apparatuses acquire at least one of the collected data from the physical devices and the virtual device data, from the virtual IoT apparatuses.

In this configuration, even when there are a plurality of virtual IoT apparatuses to be used, a virtual IoT apparatus can smoothly use collected data from physical devices.

A sixteenth aspect of the present invention is the method of the fifteenth aspect, wherein the virtual IoT apparatus transmits the collected data from the physical devices to the other virtual IoT apparatuses, and wherein the other virtual IoT apparatuses generate the virtual device data based on the collected data from the physical devices received from the virtual IoT apparatus.

In this configuration, when there are a plurality of virtual IoT apparatuses to be used, a virtual IoT apparatus acquires collected data from physical devices, and another virtual IoT apparatus generates virtual device data from the acquired collected data, which reduces processing load on an entire system compared to cases where each virtual IoT device independently performs collected data acquisition and virtual device data generation.

A seventeenth aspect of the present invention is a portable virtual IoT apparatus comprising a processor configured to generate virtual device data, the virtual device data being data to be provided from virtual devices, based on data collected by one or more physical devices forming an IoT network, wherein the processor is configured to perform operations including: acquiring information about physical devices present in a target area; acquiring collected data, which is data collected by the physical devices in the target area, by communicatively connecting to the physical devices based on the information about the physical devices; and generating the virtual device data based on the collected data from the physical devices.

In this configuration, the virtual IoT apparatus can quickly acquire virtual device data, i.e., data to be provided from virtual devices, based on data collected by physical devices present on site (in a target area).

An eighteenth aspect of the present invention is a program of controlling a computer to operate as a portable virtual IoT apparatus that generates virtual device data, the virtual device data being data to be provided from virtual devices, based on data collected by one or more physical devices forming an IoT network, wherein the program causes a processor of the computer to perform operations including: acquiring information about physical devices present in a target area; acquiring collected data, which is data collected by the physical devices in the target area, by communicatively connecting to the physical devices based on the information about the physical devices; and generating the virtual device data based on the collected data from the physical devices.

In this configuration, a computer which operates as a virtual IoT apparatus can quickly acquire virtual device data, i.e., data to be provided from virtual devices, based on data collected by physical devices present on site (in a target area).

Embodiments of the present invention will be described below with reference to the drawings.

### First Embodiment

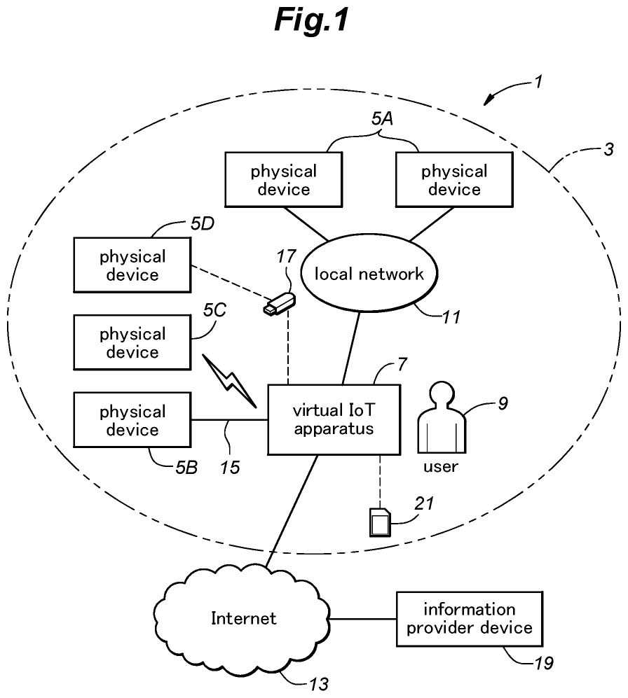

FIG. 1 is a diagram showing an overall configuration of a virtual IoT system 1 with a portable virtual IoT apparatus 7 according to a first embodiment of the present invention.

In the present embodiment, the virtual IoT system 1 can be provisionally built in a target area 3 when it becomes necessary to generate data to be provided from virtual devices (i.e., IoT devices that do not actually exist) in the target area 3. In the virtual IoT system 1, the virtual IoT apparatus 7 generates virtual device data based on data collected by physical devices (IoT devices) 5A to 5D present in the target area 3.

The target area 3 is an area which a user 9 of the virtual IoT apparatus 7 (or an administrator of the virtual IoT system 1) has determined that virtual device data is necessary to be generated therefor. The target area 3 includes, for example, an event site, a disaster site, or a crime scene. The target area 3 is not necessarily an area defined by physical boundaries, but may be an arbitrarily defined area for (i.e., surround) a site such as an event site, a disaster site, or a crime scene. However, the target area 3 does not include areas where the user 9 cannot directly observe events of interest (e.g., events related to an event site, a disaster site, or a crime scene).

The physical devices 5A-5D are sensor devices such as cameras and thermometers configured to collect data detected by their functions. The physical devices 5A are connected to the virtual IoT apparatus 7 via a local network 11 through wired communications or wireless communications based on Wi-Fi (Registered Trademark) or any other communication method. The local network 11 is a communication network built in the target area 3 and generally isolated from the Internet 13.

The physical device 5B is connected to the virtual IoT apparatus 7 via a general-purpose communication cable 15. The physical device 5C is directly connected to the virtual IoT apparatus 7 via wireless communications based on Bluetooth (Registered Trademark) or any other communication method.

The physical device 5D transfers data to and from the virtual IoT apparatus 7 via a general-purpose storage medium 17 such as a USB (Universal Serial Bus) flash drive, or an SD (Secure Digital) memory card. In this way, even when the physical device 5D is a standalone sensor device that does not require communication capabilities (or is not connected to any communication network), the virtual IoT apparatus 7 can easily acquire the data collected by the physical device 5D.

In the following, the physical devices 5A-5D are collectively referred to as “physical devices 5” when appropriate.

The number and types (including specifications) of physical devices 5 shown in FIG. 1 can be changed as needed. The virtual IoT system 1 only requires that data can be transferred (or sent/received) between the physical devices 5 and the virtual IoT apparatus 7 by any means, and not all types of devices shown as the physical devices 5A-5D are required.

The virtual IoT apparatus 7 can be in the form of a portable computer, such as a laptop, a tablet PC, and a smartphone. The virtual IoT apparatus 7 is equipped with known hardware such as a processor, a memory, and a storage. The virtual IoT apparatus 7 is configured to acquire data (such as image data or temperature data) collected by the physical devices 5 present in the target area 3, and generate virtual device data (i.e., data to be provided from virtual devices) based on the collected data from the physical devices 5 (i.e., data collected by the physical devices 5). As a result, the virtual IoT apparatus 7 can quickly acquire the virtual device data based on the collected data from the physical device 5 in the target area 3. In some cases, an application for using the generated virtual device data may be installed on the virtual IoT apparatus 7.

The virtual IoT apparatus 7 can communicate with other devices via the Internet 13. The virtual IoT apparatus 7 can acquire information required for generating virtual device data from an information provider device 19 connected to the Internet 13. The information provider device 19 may be in the form of a device such as a server or personal computer or any other device and capable of functioning as part of the virtual IoT system 1.

The virtual IoT apparatus 7 may acquire necessary information from a storage medium 21, which stores information required for generating virtual device data.

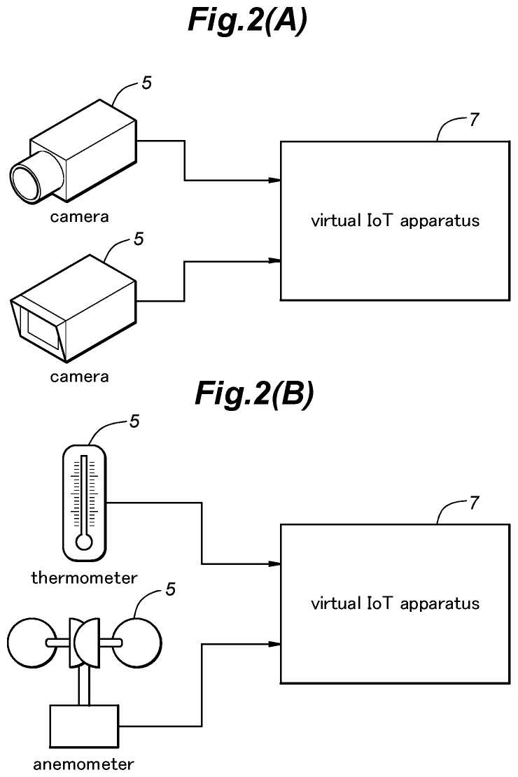

FIG. 2 is an explanatory diagram showing an example of virtual device data generation by using the virtual IoT apparatus 7.

For example, as shown in FIG. 2(A), the virtual IoT apparatus 7 acquires image data captured by a camera as collected data from a physical device 5, and generates data to be provided from a motion detection device as a virtual device (i.e., motion detection result data) based on the image data.

For example, as shown in FIG. 2(B), the virtual IoT apparatus 7 can generate data to be provided from a virtual sensory temperature indicator as a virtual device from a thermometer and a thermometer and an anemometer as physical devices 5.

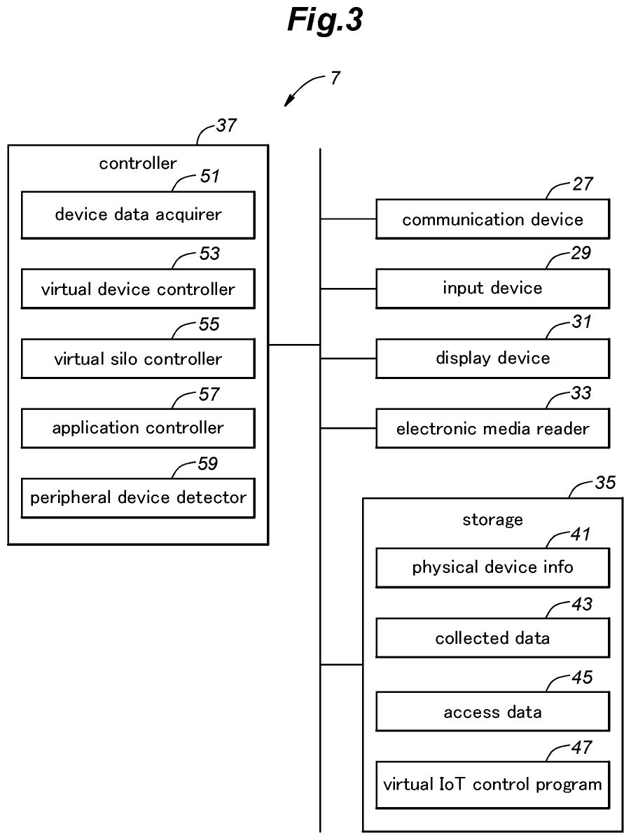

FIG. 3 is a functional block diagram of a virtual IoT apparatus 7.

The virtual IoT apparatus 7 includes a communication device 27, an input device 29, a display device 31, an electronic media reader 33, a storage 35, and a controller 37.

The communication device 27 performs wireless communications with other devices (e.g., the physical device 5C, wireless routers in the local network 11) in accordance with a known wireless communication standard. The communication device 27 includes known hardware (not shown) such as antennas, modems, and wireless communication circuits to perform wireless communications with other devices. The communication device 27 is also provided with an interface (not shown) to which the communication cable 15 can be connected and can perform wired communications with other devices (e.g., the physical device 5B). The hardware configuration of the communication device 27 is not limited to this and any hardware configuration may be used as long as the device can perform at least wireless or wired communications with other devices.

The input device 29 is equipped with known hardware such as a keyboard or touch panel on which the user 9 can perform input operations.

The display device 31 is equipped with known hardware such as a liquid crystal display. The display device 31 may be comprised primarily of a touch panel together with the input device 29.

The electronic media reader 33 is equipped with an interface that can be connected with storage media such as USB flash drives and SD memory cards (in this case, storage media 17 and 21). The electronic media reader 33 can also function as a reader/writer configured to read data from and write data to the storage media.

The storage 35 includes a storage device such as an HDD (Hard Disk Drive) and an SSD (Solid State Drive). The storage 35 stores physical device information 41, collected data 43, access data 45, and virtual IoT control programs 47.

The physical device information 41 is information about physical devices 5. The physical device information 41 can include, for example, information such as the identifier, location, function, and specifications of each physical device 5. However, the physical device information 41 is only required to include at least information that enables the virtual IoT apparatus 7 to detect physical devices 5 present in the target area 3.

The virtual IoT apparatus 7 may, for example, acquire the physical device information 41 via the storage medium 21. Alternatively, the virtual IoT apparatus 7 may acquire the physical device information 41 from the information provider device 19 via the Internet 13. This configuration allows the virtual IoT apparatus 7 to acquire information about the physical device 5 without moving to the target area 3. The user 9 of the virtual IoT apparatus 7 can check in advance (i.e., before bringing the virtual IoT apparatus 7 to the target area 3) whether the physical devices required for virtual device data generating are present in the target area 3. Referring to the physical device information 41, the user 9 can perform necessary tasks (e.g., setting up wireless communication, installing communication cables) to communicatively connect the physical devices 5 to the virtual IoT apparatus 7.

The collected data 43 includes data collected by physical devices 5. The collected data 43 can include, for example, time-series image data and temperature data.

The access data 45 is data related to authorization required for the virtual IoT apparatus 7 to access and use data from physical devices 5 when security settings are made for the data from the physical devices 5. The virtual IoT apparatus 7 can acquire the data related to authorization required to access and use data, for example, via the storage medium 21. In such a case, the user 9 can stop by a facility near the site (e.g., a convenience store, a utility pole, ground equipment for power supply, a mailbox, a signal, a street light, a guardrail, a station building, a bus stop, or a government) to receive the storage medium 21. This configuration allows the virtual IoT apparatus 7 to easily acquire data related to authorization required to access and use data even when the communication network environment in the target area 3 is not sufficiently built. This configuration also prevents data related to authorization required to access and use data from being acquired by a malicious third party via a communication network.

The virtual IoT control programs 47 are programs for causing the virtual IoT apparatus 7 (processor in a computer) to execute operations for virtual device data generation based on data collected by physical devices 5. The virtual IoT control programs 47 may include an application software program for using the generated virtual device data.

The controller 37 includes a device data acquirer 51, a virtual device controller 53, a virtual silo controller 55, an application controller 57, and a peripheral device detector 59.

The device data acquirer 51 acquires data collected by physical devices 5 present in the target area 3. The acquired data is sequentially stored in the storage 35. However, some of the data acquired by the device data acquirer 51 may include data collected by physical devices installed outside the target area 3 (e.g., physical devices connected to the Internet 13). This configuration allows the virtual IoT apparatus 7 to generate virtual device data using not only the collected data of physical devices 5, which is highly relevant to an event of interest for the user 9, but also the collected data from physical devices that are less directly relevant to the event of interest.

The virtual device controller 53 manages and processes collected data from physical devices 5 acquired by the device data acquirer 51. The virtual device controller 53 generates data to be provided from a virtual device (virtual device data) requested by the user 9 based on the acquired collected data from physical devices 5. The virtual device controller 53 is capable of converting a unique data format of collected data from physical devices 5 into a general-purpose data format.

The virtual silo controller 55 functions as an interface for applications that use virtual device data. The virtual silo controller 55 converts the format of virtual device data into a specific data format. In the present embodiment, the virtual silo controller 55 converts the format of virtual device data into a data format adapted for the application controller 57 and provides the converted data to the application controller 57.

The application controller 57 performs operations using virtual device data according to application programs, to thereby allow the virtual IoT apparatus 7 to, by using the above-described motion detection result data (virtual device data), function as various systems, such as a system for monitoring parking lots and providing information to users, a system for monitoring garbage collection sites, a system for detecting wildlife for vermin control, and a system for detecting a person for confirmation of the safety of the person. For example, by using the above-described data provided from a thermometer (virtual device data), the virtual IoT apparatus 7 can also function as a system for environmental improvement for users of a temporary venue.

The peripheral device detector 59 can detect physical devices 5 which are in the target area 3 and are not included in the physical device information 41. For example, the peripheral device detector 59 can receive radio signals transmitted from physical devices capable of performing wireless communications and detect nearby physical devices based on information contained in the radio signals. In this configuration, even when presence of a physical device in the target area 3 is not publicly known, the virtual IoT apparatus 7 can detect a radio signal therefrom, thereby acquiring data collected by the physical device.

In addition, the peripheral device detector 59 can display information about the detected physical device (e.g., identifier or location) on the display device 31 to thereby encourage the user 9 to connect the detected physical device to the virtual IoT apparatus 7.

The controller 37 includes one or more hardware processors (such as CPU and GPU). The functions of the controller 37 are implemented by a processor executing the virtual IoT control programs 47. Controls performed by the controller 37 are not limited to controls on the operation for virtual device data generation. The controller 37 can comprehensively control the operations of the respective parts of the virtual IoT apparatus 7.

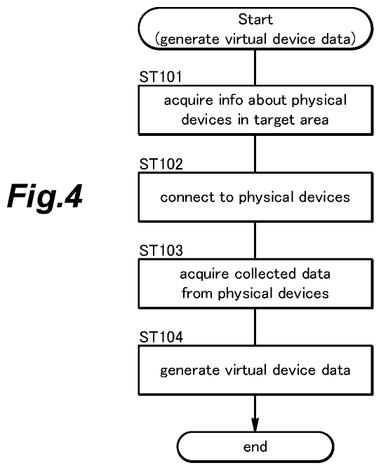

FIG. 4 is a flow chart showing an operation procedure of an operation of virtual device data generation.

The virtual IoT apparatus 7 is usually brought into the target area 3 from outside by the user 9 when the virtual IoT system 1 is built. Then, the virtual IoT apparatus 7 acquires information on physical devices in the target area 3 (ST101). The virtual IoT apparatus 7 stores the acquired physical device information in the storage 35 as physical device information 41. However, the virtual IoT apparatus 7 may acquire at least part of information on the physical devices in the target area 3 before the virtual IoT apparatus 7 is brought into the target area 3.

Next, the virtual IoT apparatus 7 connects communicatively to nearby physical devices 5 based on the physical device information 41 (ST102). Then, the user 9 can build a new local network 11 or place communication cables 15 between the virtual IoT apparatus 7 and physical devices 5, as necessary.

Then, the virtual IoT apparatus 7 acquires collected data from the detected physical devices 5 in sequence (ST103). The virtual IoT apparatus 7 performs the operation of acquiring collected data in a continuous manner over a predetermined period of time. In some cases, the virtual IoT apparatus 7 may acquire a batch of collected data accumulated in the physical devices 5 for a predetermined period of time.

Then, the virtual IoT apparatus 7 generates virtual device data based on the collected data acquired from the physical devices 5 (ST104). The application controller 57 performs a processing operation on the generated virtual device data. Alternatively, the virtual IoT apparatus 7 may provide the virtual device data to other users (or data processing devices) who need the data.

(Variant of First Embodiment)

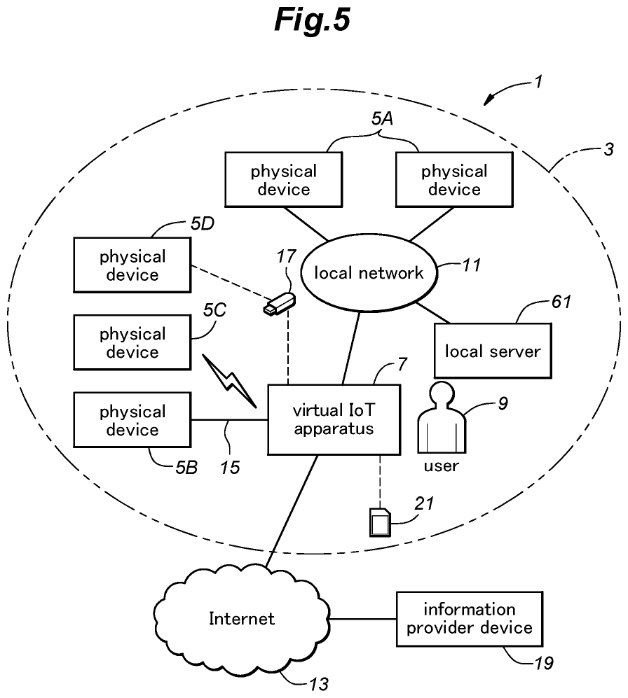

FIG. 5 is a diagram showing an overall configuration of a virtual IoT system 1 according to a variant of the first embodiment of the present invention.

In the variant of the first embodiment, as shown in FIG. 5, a local server 61 is connected to the local network 11. The local server 61 is equipped with known hardware such as a processor, a memory, and a storage. The local server 61 manages the physical devices 5A connected to the local network 11 and data collected by the physical devices 5A.

The virtual IoT apparatus 7 can be communicatively connected to the local server 61 via the local network 11 so that the virtual IoT apparatus 7 can acquire collected data from each physical device 5A from the local server 61. The virtual IoT apparatus 7 may be communicatively connected directly to the local server 61 without going through the local network 11.

In the virtual IoT system 1 so configured according to the present embodiment, the virtual IoT apparatus 7 can easily acquire collected data from the physical devices 5A, which are isolated from the Internet 13, via the local server.

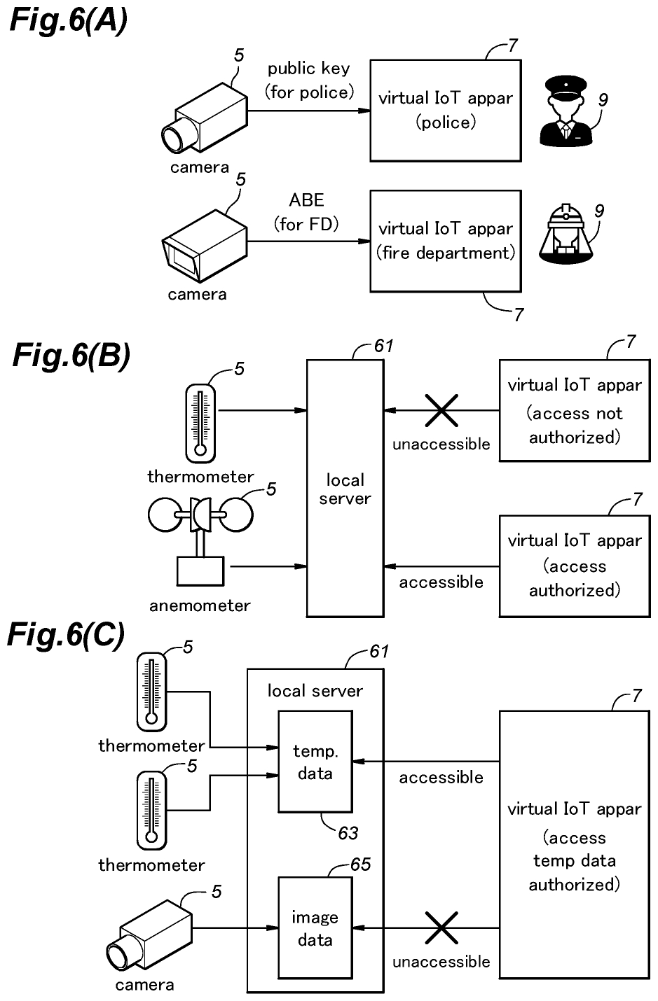

FIG. 6 is an explanatory diagram showing an example of restriction on use of data collected by physical devices 5.

In some cases, an administrator of a physical device 5 located in the target area 3 does not want collected data from the physical device to be widely available to unspecified third parties or wants to limit the users of the collected data.

As shown in FIG. 6(A), for example, the virtual IoT system 1 may be configured such that the virtual IoT system 1 can encrypt data collected by physical device 5 based on a public key, and provide that encrypted data to the virtual IoT apparatus 7 used by a specific user 9 (police in this example) who owns the secret key. In addition, the virtual IoT system 1 may also be configured such that the virtual IoT system 1 can encrypt data collected by physical devices 5 based on attribute-based encryption (ABE: Attribute-Based Encryption), and provide the encrypted data to the virtual IoT apparatus 7 used by a specific user 9 (fire department in this example) having a specified attribute.

Furthermore, as shown in FIG. 6(B), for example, the virtual IoT system 1 may be configured such that, when virtual IoT apparatuses 7 acquire data collected by physical devices via the local server 61, an administrator of the local server 61 can grant only a specific virtual IoT apparatus 7 access to the local server 61. The local server 61 transmits collected data from physical devices 5 only to the virtual IoT apparatus 7 that has access to, i.e., is authorized to access the local server.

In this configuration, a virtual IoT apparatus 7 which is unauthorized to access the local server is not allowed to use collected data from physical devices, and thus the administrator of the local server 61 can ensure security of collected data from the physical devices 5 connected to the local network 11. In some cases, the administrator of the local server 61 may grant access thereto for each attribute of the user 9 (e.g., affiliation of the user 9).

Moreover, as shown in FIG. 6(C), for example, the virtual IoT system 1 may be configured such that an administrator of the local server 61 can grant the virtual IoT apparatus 7 authorization (in the form of token, for example) to use collected data of a specific type (data attribute).

In this example, the virtual IoT apparatus 7 can acquire collected data (in this case, temperature data 63) which the local server 61 grants authorization to use, but cannot acquire collected data (in this case, image data 65) which the local server 61 does not grant authorization to use. The local server 61 transmits only the collected data (in this case, temperature data 63) having data attribute for which the local server 61 grants the virtual IoT apparatus 7 authorization to use.

In this configuration, the virtual IoT apparatus 7 is not allowed to use collected data having a data attribute for which the virtual IoT apparatus 7 is unauthorized to use, and thus an administrator of the local server 61 can ensure security of collected data from the physical devices 5 connected to the local network 11.

A usable time period (valid period) may be defined such that encryption of data, access to the local server 61 and authorization to use collected data as described above are valid only during the usable time period. In this configuration, the virtual IoT apparatus 7 does not use collected data from physical devices 5 outside the usable time period, which improves the security of collected data from the physical devices 5.

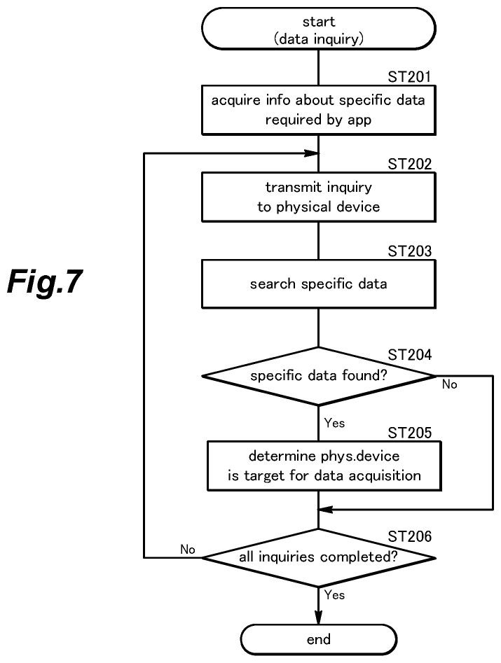

FIG. 7 is a flow chart showing an operation procedure of an operation of data inquiry from a virtual IoT apparatus 7 to physical devices 5.

The virtual IoT apparatus 7 can perform an operation (data inquiry operation) to transmit an inquiry to a physical device 5 communicatively connected thereto, inquiring as to whether or not the physical device 5 contain specific data that the virtual IoT apparatus 7 needs. For example, the virtual IoT apparatus 7 performs the data inquiry operation shown in FIG. 7 before step ST103 (data acquisition) shown in FIG. 4.

As shown in FIG. 7, the virtual IoT apparatus 7 first acquires information about the specific data required by an application (in this case, application controller 57), which is to use virtual device data (ST201). Examples of the specific data required by the application include shot image data of a specific subject.

Next, the virtual IoT apparatus 7 transmits an inquiry (inquiry data) to the physical device 5 as to whether or not collected data in the physical devices 5 contain specific data based on the information about the specific data (ST202). Examples of inquiry data include shot image data of a specific subject.

Upon receiving the inquiry, the physical device 5 searches its collected data to check whether the collected data contains the specific data required by the application (ST203). The physical device 5 transmits the search result to the virtual IoT apparatus 7 as a response to the inquiry data. The virtual IoT apparatus 7 can display information included in the response on the display device 31 for the user 9.

When the collected data contains the specific data (Yes in ST204), the virtual IoT apparatus 7 determines the physical device 5 as a target for data acquisition (ST205). When the collected data does not contain the specific data (No in ST204), the virtual IoT apparatus 7 excludes the physical device 5 from targets for data acquisition in step ST103 shown in FIG. 4.

The above steps ST202-ST205 are repeated until the inquiries to all the physical devices 5 are completed (Yes in ST206).

The above-described data inquiry operation allows the virtual IoT apparatus 7 to preliminarily check whether or not specific data necessary for virtual device data generation is contained in the collected data in the physical devices 5, thereby preventing unnecessary data acquisition. In addition, when collected data to be searched for specific data includes image data that can include unrelated persons, this configuration advantageously enables protection of the privacy of unrelated persons and others in the image data.

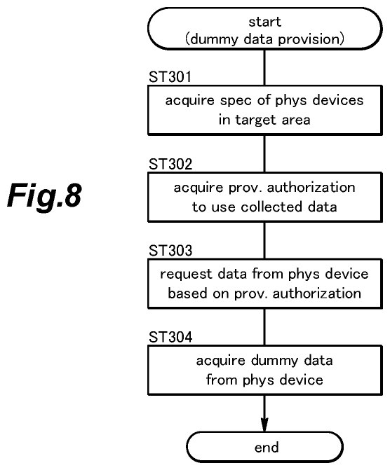

FIG. 8 is a flow chart showing an operation procedure of an operation to provide dummy data from a physical device 5 to the virtual IoT apparatus 7.

Even when the presence of a physical device 5 in the target area 3 is detected, it is not always possible for the virtual IoT apparatus 7 to actually communicate with the physical device because the physical device 5 and the virtual IoT apparatus 7 may differ in the interface or the communication protocol, or in the case of wireless communications, radio waves may be blocked by buildings or other unexpected communication conditions. Even when the virtual IoT apparatus 7 is able to acquire collected data from the physical device 5, it is not always possible to use the collected data for virtual device data generation because the data may have an unknown data format, the data may lack essential information, the data may not be accurate enough, or the data may be unexpected one. Thus, the virtual IoT system 1 may be configured such that the virtual IoT apparatus 7 can temporarily connect to a desired physical device 5 in advance and acquire dummy data from the physical device 5.

As shown in FIG. 8, the virtual IoT apparatus 7 first acquires information about the specifications of a physical device 5 in the target area 3 (ST301). For example, the virtual IoT apparatus 7 can acquire information about the specifications of the physical device 5 from the information provider device 19 via the Internet 13.

Next, the virtual IoT apparatus 7 selects the physical device 5 the user 9 requires based on the information about the specifications of the physical device 5 and acquires a provisional authorization to use the collected data from the physical device 5 (ST302). For example, the virtual IoT apparatus 7 can acquire information on the provisional authorization to use the data collected by the physical device 5, from the information provider device 19 via the Internet 13.

The virtual IoT apparatus 7 then executes a data request to the target physical device 5 based on the provisional authorization to use the data (ST303). When receiving the data request from virtual IoT apparatus 7 based on the provisional authorization to use the data, the physical device 5 transmits dummy data to the virtual IoT apparatus 7, resulting in that the virtual IoT apparatus 7 acquires the dummy data (ST304). The dummy data has the same attributes and data format as the data collected by the physical device 5, although data values are different from those of the actual data collected by the physical device 5. Alternatively, the dummy data may be old actual data that was collected by physical device 5 in the past.

The above-described operation to provide dummy data allows the user 9 of the virtual IoT apparatus 7 to preliminary confirm whether the virtual IoT apparatus 7 can successfully communicate with the desired physical device 5. In addition, the virtual IoT apparatus 7 can do trial use of collected data of the physical device (rehearsal for virtual device data generation for the virtual device) based on the dummy data provided by the physical device 5. As a result, the user 9 of the virtual IoT apparatus 7 can preliminary confirm whether the collection data from the desired physical device can actually be used to generate virtual device data.

### Second Embodiment

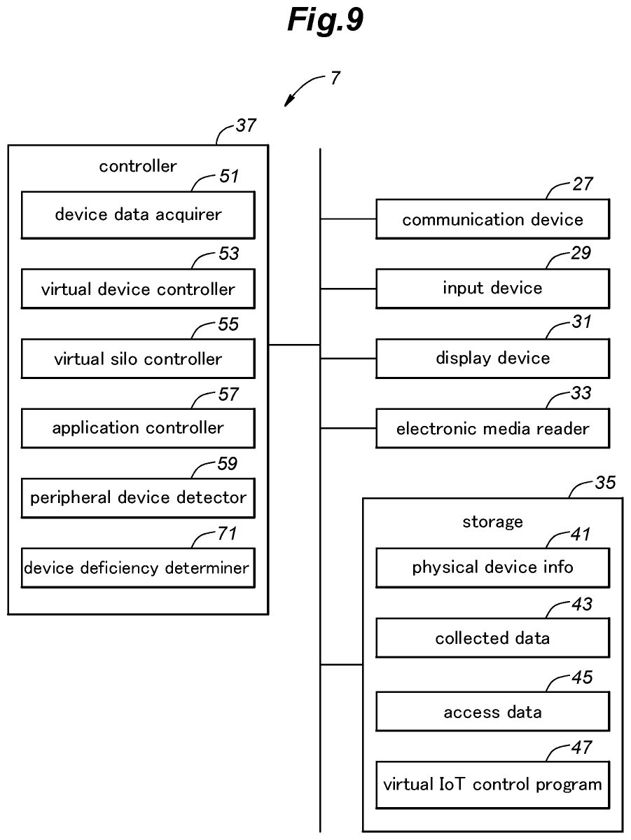

FIG. 9 is a functional block diagram of a virtual IoT apparatus 7 according to a second embodiment of the present invention. In the virtual IoT apparatus 7 in FIG. 9, repeat use of reference numerals is intended to represent the same or analogous features or elements of the virtual IoT apparatus 7 of the first embodiment. Except for what will be discussed here, the virtual IoT apparatus 7 of the second embodiment is the same as that of the first embodiment.

In the virtual IoT apparatus 7 of the second embodiment, the controller 37 includes a device deficiency determiner 71. The device deficiency determiner 71 determines whether or not physical devices in the target area 3 are deficient for generating the virtual device (i.e., physical devices necessary for generating virtual device data are not installed).

When determining that physical devices are deficient for generating virtual device data, the device deficiency determiner 71 reports the deficiency of the physical devices 5 to the user 9. For example, the device deficiency determiner 71 can display information about the deficiency of the physical devices 5 on the display device 31 to thereby report it to the user 9. In this way, the virtual IoT apparatus 7 can inform the user 9 of the deficiency of the physical device 5 to thereby encourage the user 9 to install necessary physical devices.

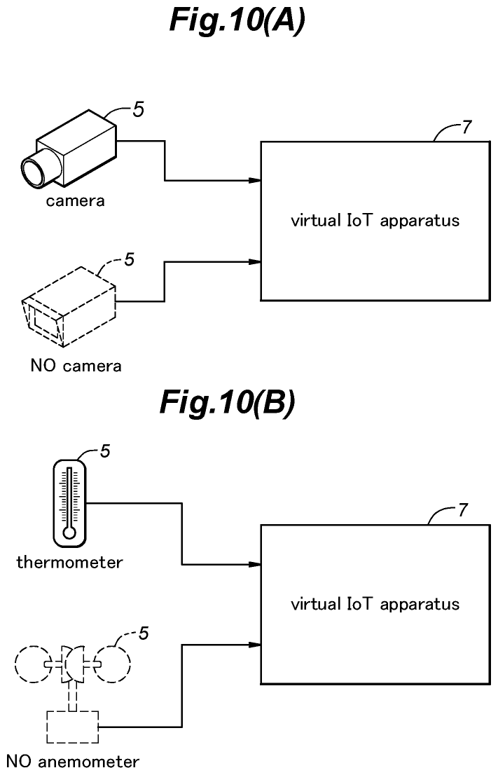

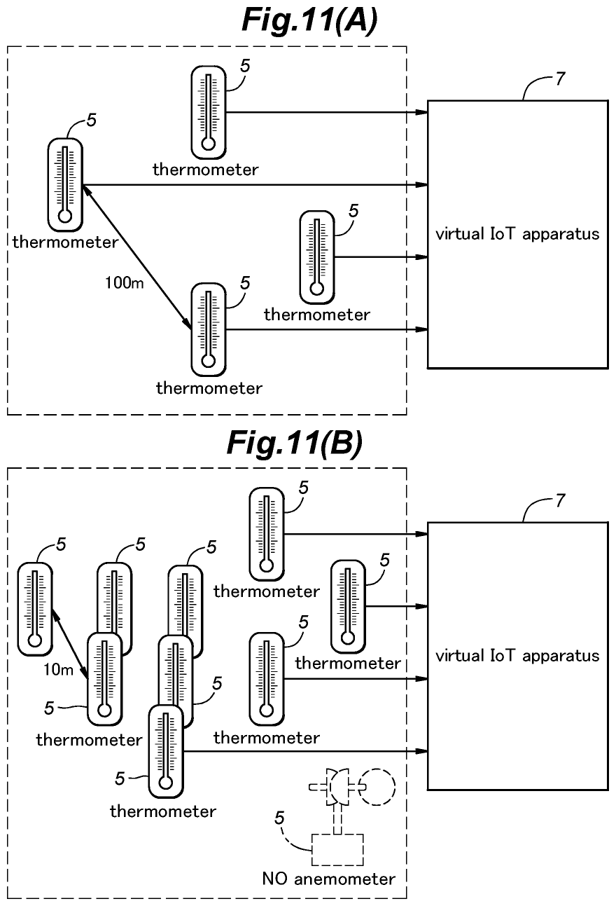

FIGS. 10 and 11 are explanatory diagrams showing examples of deficiency of physical devices.

The example shown in FIG. 10(A) shows a situation where cameras at two locations are required as physical devices 5 to generate virtual device data, and a camera is installed at one location but not at the other location. Due to the lack of collected image data, the virtual IoT apparatus 7 can only acquire person detection result data from one location as the collected data from the virtual devices. Thus, the user 9 needs to install an additional camera as a physical device 5 at a location where no camera is installed.

In the example shown in FIG. 10(B), a thermometer is installed, but an anemometer is not installed, and the virtual IoT apparatus 7 cannot generate data from a thermometer as a virtual device. Thus, the user 9 needs to additionally install an anemometer as a physical device 5.

In the example shown in FIG. 11(A), the user 9 needs to acquire temperature data in 10-meter increments in order to determine the distribution of temperature in target area 3. However, in the target area 3, thermometers as physical devices 5 are installed every 100 meters. Thus, the virtual IoT apparatus 7 cannot acquire temperature data with the required accuracy (number or density of measurement points). Thus, the user 9 needs to install additional physical devices 5 as physical devices 5 so as to compensate for deficiency in the number or density of thermometers (the number of physical devices 5 per unit area).

In the example shown in FIG. 11(B), the user 9 wants to acquire temperature data in 10-meter increments in order to determine the distribution of the temperature in target area 3. In the target area 3, thermometers as physical devices 5 are installed every 10 meters, but anemometers are not installed, and thus the virtual IoT apparatus 7 cannot generate data from thermometer as virtual devices. Thus, the user 9 needs to install an additional anemometer as a physical device 5.

Even when the number, density, and each installation interval of physical devices 5 in the target area 3 are appropriate, the capabilities (specifications) of each of the physical devices 5 may not meet the requirements. For example, even when a camera is provided s as a physical device 5 in the target area 3, the quality of images acquired from the camera may not be sufficient. In such a case, the device deficiency determiner 71 still determines that physical devices are deficient for generating virtual device data, and reports the deficiency of the physical devices 5 to the user 9. Then, the user 9 can either install an additional physical device with sufficient specifications or relax the specifications of necessary data.

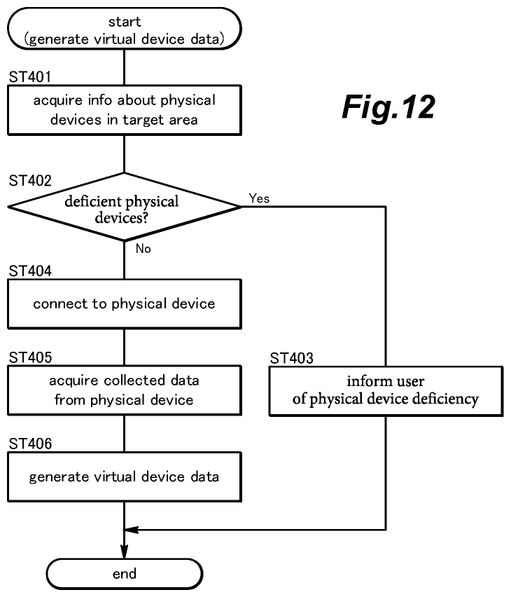

FIG. 12 is a flow chart showing an operation procedure of an operation of virtual device data generation according to the second embodiment.

The virtual IoT apparatus 7 first acquires information on physical devices in the target area 3 (ST401), in a similar manner to step ST101 in FIG. 4.

Next, the virtual IoT apparatus 7 determines whether the physical devices in the target area 3 are deficient or not. When determining the physical devices are deficient (Yes in ST402), the virtual IoT apparatus 7 reports the physical device deficiency to the user 9 (ST403).

When determining that the physical devices are not deficient (No in ST402), the virtual IoT apparatus 7 performs operations in steps ST404-ST406 as in steps ST102-ST104 in FIG. 4, respectively.

### Third Embodiment

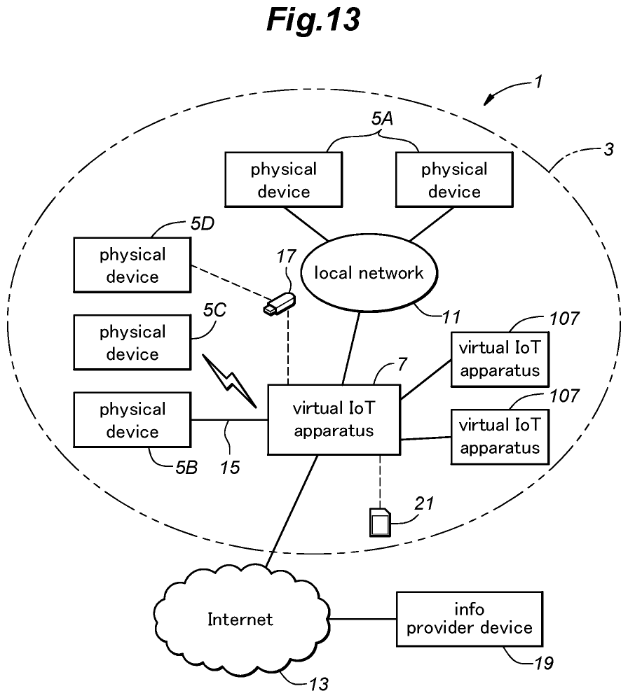

FIG. 13 is a diagram showing an overall configuration of a virtual IoT system with a portable virtual IoT apparatus 7 according to a third embodiment of the present invention. In FIG. 13, repeat use of reference numerals is intended to represent the same or analogous features or elements of the virtual IoT apparatus 7 of the first embodiment. Except for what will be discussed here, the virtual IoT apparatus 7 of the third embodiment is the same as that of the first embodiment.

In the virtual IoT system 1 of the third embodiment, other virtual IoT apparatuses 107 are communicatively connected to the virtual IoT apparatus 7. Thus, the other virtual IoT apparatuses 107 can acquire necessary data (e.g., at least one of the collected data from a physical device 5 and that from a virtual device) without the need to be communicatively connected to the physical device 5. The other virtual IoT apparatuses 107 have the same configuration as the virtual IoT apparatuses 7 described above. Alternatively, the other virtual IoT apparatuses 107 may have a configuration formed by making some modifications to (e.g. omissions of some features) the configuration of the virtual IoT apparatuses 7.

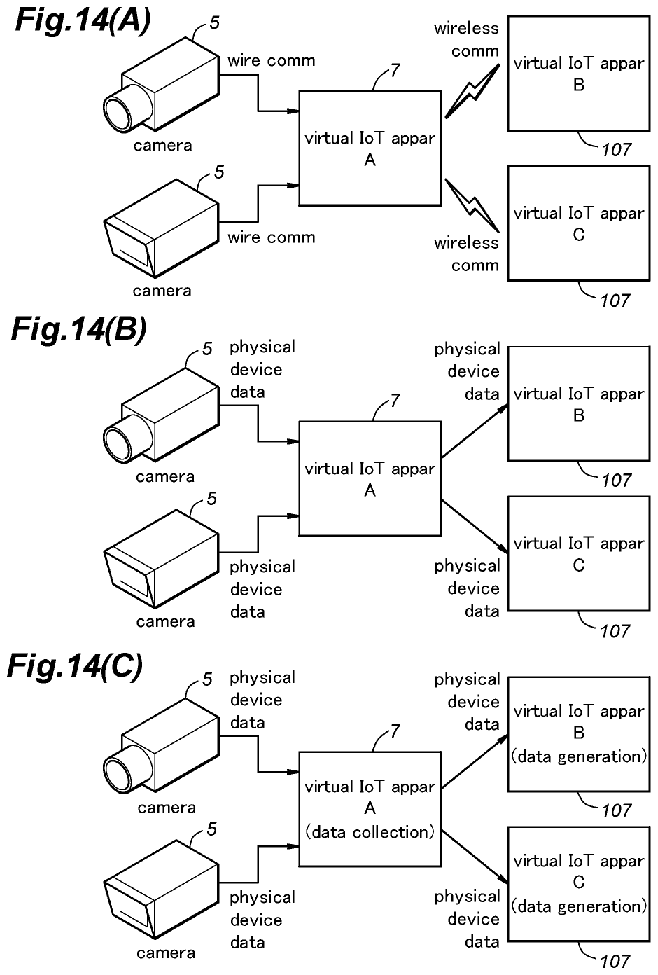

FIG. 14 is an explanatory diagram showing an example of communication connection (FIG. 14(A)) and data transfer between a virtual IoT apparatus and other virtual IoT apparatuses (FIGS. 14(B) and 14(C)).

In the example shown in FIG. 14(A), the virtual IoT apparatus 7 is connected to physical devices 5 through wired communications. Other virtual IoT apparatuses are connected to the virtual IoT apparatus 7 through wireless communications.

This configuration allows data collected by the physical devices 5 to be smoothly used by multiple virtual IoT apparatuses (in this case, the virtual IoT apparatus 7 and other virtual IoT apparatuses 107) even when the physical devices 5 have relatively low or no wireless communication capability.

In the example shown in FIG. 14(B), the virtual IoT apparatus 7 acquires the collected data from physical devices 5 and provides virtual device data generated based on the collected data to other virtual IoT apparatuses 107.

In this configuration, when multiple virtual IoT apparatuses (in this case, the virtual IoT apparatus 7 and other virtual IoT apparatuses 107) are used, the other virtual IoT apparatuses 107 do not need to generate virtual device data, which reduces processing load on an entire system compared to cases where each virtual IoT apparatus independently performs virtual device data generation.

In the example shown in FIG. 14(C), the virtual IoT apparatus 7 acquires the collected data from physical devices 5 and provides (transfers) the acquired collected data to other virtual IoT apparatuses 107.

In this configuration, when multiple virtual IoT apparatuses (in this case, the virtual IoT apparatus 7 and other virtual IoT apparatuses 107) are used, the other virtual IoT apparatuses 107 do not need to perform operations for connection to the physical devices (such as acquiring information about physical devices, setting up wireless communications, installing communication cables). In some cases, instead of the virtual IoT apparatus 7, a data relay device may be provided and used to transfer the collected data from the physical device 5 to the other virtual IoT apparatuses 107.

(Variant of Third Embodiment)

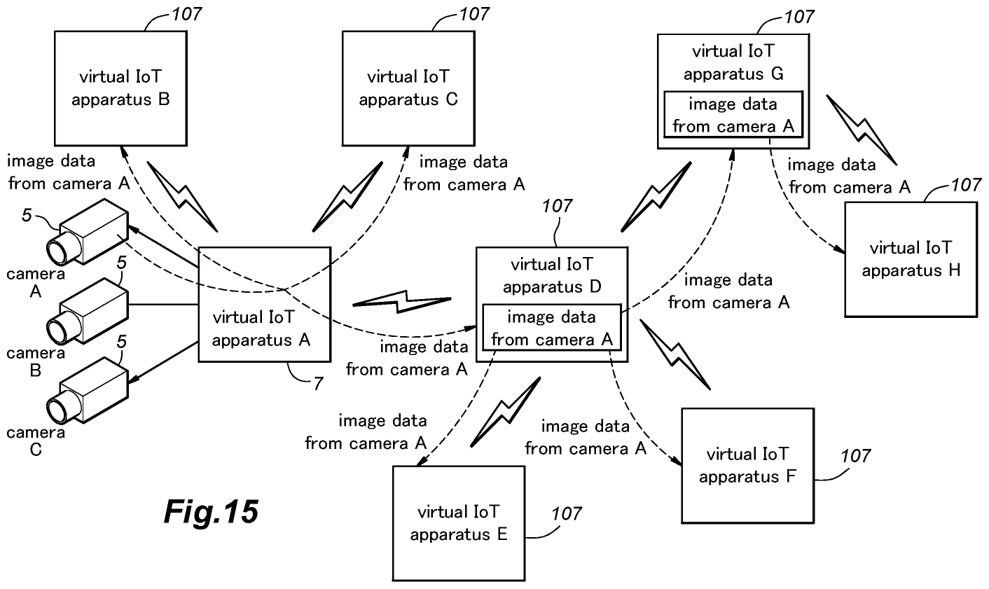

FIG. 15 is a diagram showing an overall configuration of a virtual IoT system 1 according to a variant of the third embodiment of the present invention. In this embodiment, the form of communication connection between a virtual IoT apparatus 7 and other virtual IoT apparatuses 107 is more scaled up the third embodiment. Except for what will be discussed here, the virtual IoT system 1 of the third embodiment is the same as that of the third embodiment. As shown in FIG. 15, the virtual IoT system 1 can include a number of other virtual IoT apparatuses 107 along with the virtual IoT apparatus 7. In the following, the virtual IoT apparatus 7 and other virtual IoT apparatuses 107 are distinguishably referred to as virtual IoT apparatuses A-H. Physical devices 5 i.e., cameras are also distinguishably referred to as cameras A-C.

In this example, the virtual IoT apparatus A is communicatively connected to the cameras A-C. Each of the virtual IoT apparatus B-D is not communicatively connected to the camera A-C, but to the virtual IoT apparatus A. The virtual IoT apparatuses E-G are not communicatively connected to the cameras A-C and the virtual IoT apparatuses A-C, but to the virtual IoT apparatus D. The virtual IoT apparatus H is not communicatively connected to the cameras A-C and the virtual IoT apparatus A-F, but to the virtual IoT apparatus G.

In this configuration, the virtual IoT apparatus A can acquire video data (data collected by a physical device 5) from the camera A and provide (transfer) the acquired video data to the virtual IoT apparatuses B-D, respectively.

The virtual IoT apparatus D has a function of caching collected data from physical devices 5 (in this case, the video data from the camera A), which allows the virtual IoT apparatus D to provide cached video data from the camera A to the virtual IoT apparatuses E-G, respectively.

The virtual IoT apparatus G, like the virtual IoT apparatus D, has a function of caching collected data from physical devices 5 (in this case, the video data from the camera A), which allows the virtual IoT apparatus G to provide cached video data from the camera A to the virtual IoT apparatus H, respectively.

This configuration allows the multiple virtual IoT apparatuses (in this case, the virtual IoT apparatus 7 and other virtual IoT apparatuses 107) to independently use collected data from physical devices (in this case, the cameras A-C) without the need to be communicatively connected to the physical devices 5.

The form of communication connections of multiple virtual IoT apparatuses can be modified in various ways. For example, the multiple virtual IoT apparatuses may be interconnected by any of wired communications, wireless communications, a storage medium or any combination thereof for data transfer with each other. The multiple virtual IoT apparatuses may be connected in a star configuration through a gateway, or may be connected in a linear or mesh manner through multi-hop communications.

While specific embodiments of the present invention are described herein for illustrative purposes, the present invention is not limited to the specific embodiments. It will be understood that various changes, substitutions, additions, and omissions may be made to elements of the embodiments without departing from the scope of the invention. In addition, elements and features of the different embodiments may be combined with each other as appropriate to yield an embodiment which is within the scope of the present invention.

### INDUSTRIAL APPLICABILITY

A portable virtual IoT apparatus for generating virtual device data, a virtual device data generation method using the same, and a computer program of the same according to the present invention have an effect of enabling quick acquisition of virtual device data from virtual devices based on data collected by physical devices present on site (in a target area), and are useful as a portable virtual IoT apparatus for generating virtual device data, a virtual device data generation method using the same, and a computer program of the same.

### Glossary

1 virtual IoT system
3 target area
5 physical device
7 virtual IoT hub
9 user
11 local network
13 Internet
15 communication cable
17 storage media
19 information provider device
21 storage medium
27 communication device
29 input device
31 display device
33 electronic media reader
35 storage
37 controller
41 physical device information
43 collected data
45 access data
47 virtual IoT control program
51 device data acquirer
53 virtual device controller
55 virtual silo controller
57 application controller
59 peripheral device detector
61 local server
63 temperature data
65 video data
71 device deficiency determiner
107 other virtual IoT apparatus

1. A method of generating virtual device data, the virtual device data being data to be provided from virtual devices, by using a portable virtual IoT apparatus based on data collected by one or more physical devices forming an IoT network, the method comprising:
causing the virtual IoT apparatus to perform operations including:
acquiring information about physical devices present in a target area;
acquiring collected data, which is data collected by the physical devices in the target area, by communicatively connecting to the physical devices based on the information about the physical devices; and
generating the virtual device data based on the collected data from the physical devices.

2. The method as claimed in claim 1, wherein at least one of the physical devices has wireless communication capabilities, and
wherein the virtual IoT apparatus is caused to:
detect physical devices present in the target area based on wireless signals transmitted therefrom; and
acquire the collected data from the physical devices by communicatively connecting to each of the detected physical devices.

3. The method as claimed in claim 1, wherein the virtual IoT apparatus is caused to:
determine whether or not the physical devices are deficient for generating the virtual device data based on the information about the physical devices; and
when determining that the physical devices are deficient, inform a user of the deficiency of the physical devices.

4. The method as claimed in claim 3, wherein the virtual IoT apparatus is caused to:
inform the user of a fact that a number or density of physical devices present in the target area is not sufficient to generate the virtual device data, as the deficiency of the physical devices.

5. The method as claimed in claim 3, wherein the virtual IoT apparatus is caused to:
inform the user of a fact that specifications of physical devices present in the target area are not sufficient to generate the virtual device data, as the deficiency of the physical devices.

6. The method as claimed in claim 1, wherein the collected data from the physical devices is set such that authorization is required to use the collected data, and
wherein the virtual IoT apparatus can generate the virtual device data based on the collected data from the physical devices only when the virtual IoT apparatus is authorized to access the data.

7. The method as claimed in claim 6, wherein a usable time period is defined such that the authorization to use the collected data is valid only during the usable time period, and
wherein the virtual IoT apparatus can generate the virtual device data based on the collected data from the physical devices only during the usable time period.

8. The method as claimed in claim 1, wherein the virtual IoT apparatus is caused to:
acquire a provisional authorization to use the collected data from the physical devices; and
transmit a data request to the physical devices based on the provisional authorization, and
wherein, when a physical device receives the data request based on the provisional authorization from the virtual IoT apparatus, the physical device transmits dummy data associated with the collected data to the virtual IoT apparatus.

9. The method as claimed in claim 1, wherein, before acquiring the collected data from the physical devices, the virtual IoT apparatus transmits to the physical devices an inquiry as to whether or not the collected data includes specific data, and
wherein, when a physical device receives the inquiry, the physical device transmits a response to the inquiry to the virtual IoT apparatus.

10. The method as claimed in claim 9, wherein the collected data includes image data,
wherein the specific data is data of a subject required to generate the virtual device data.

11. The method as claimed in claim 1, wherein a local network isolated from the Internet is provided in the target area,
wherein the physical devices and a local server for acquiring the collected data from the physical devices are connected to the local network, and
wherein the virtual IoT apparatus is communicatively connected to the local server to thereby acquire the collected data from the physical devices via the local server.

12. The method as claimed in claim 11, wherein the local server transmits the collected data from the physical devices to the virtual IoT apparatus only when the virtual IoT apparatus is authorized to access the local server.

13. The method as claimed in claim 11, wherein the collected data from the physical devices is set such that authorization defined for each data attribute is required to use the data, and
wherein the local server transmits only the collected data with data attributes for which the virtual IoT apparatus has the authorization to use, to the virtual IoT apparatus.

14. The method as claimed in claim 1, wherein a local network isolated from the Internet is provided in the target area,
wherein the physical devices are connected to the local network, and
wherein the virtual IoT apparatus acquires the information about the physical devices via the Internet.

15. The method as claimed in claim 1, wherein the virtual IoT apparatus is communicatively connected to one or more other virtual IoT apparatuses; and
wherein the other virtual IoT apparatuses acquire at least one of the collected data from the physical devices and the virtual device data, from the virtual IoT apparatuses.

16. The method as claimed in claim 15, wherein the virtual IoT apparatus transmits the collected data from the physical devices to the other virtual IoT apparatuses, and
wherein the other virtual IoT apparatuses generate the virtual device data based on the collected data from the physical devices received from the virtual IoT apparatus.

17. A portable virtual IoT apparatus comprising a processor configured to generate virtual device data, the virtual device data being data to be provided from virtual devices, based on data collected by one or more physical devices forming an IoT network,
wherein the processor is configured to perform operations including:
acquiring information about physical devices present in a target area;
acquiring collected data, which is data collected by the physical devices in the target area, by communicatively connecting to the physical devices based on the information about the physical devices; and
generating the virtual device data based on the collected data from the physical devices.

18. A program of controlling a computer to operate as a portable virtual IoT apparatus that generates virtual device data, the virtual device data being data to be provided from virtual devices, based on data collected by one or more physical devices forming an IoT network,
wherein the program causes a processor of the computer to perform operations including:
acquiring information about physical devices present in a target area;
acquiring collected data, which is data collected by the physical devices in the target area, by communicatively connecting to the physical devices based on the information about the physical devices; and
generating the virtual device data based on the collected data from the physical devices.
